(19) United States
(12) Patent Application Publication
(10) Pub. No.: US 2026/0192343 A1
(43) Pub. Date: Jul. 9, 2026

(54) WINDOW CLEANING MACHINE

(71) Applicant: Hobot Technology Inc., Zhubei City (TW)

(72) Inventors: Chi-Mou CHAO, Zhubei City (TW); Min-Chih Tseng, Zhubei City (TW)

(21) Appl. No.: 19/408,986

(22) Filed: Dec. 4, 2025

(30) Foreign Application Priority Data
Jan. 8, 2025 (TW) 114100806

(51) Int. Cl. B08B 11/04

(52) U.S. Cl. CPC B08B 11/04

(57) ABSTRACT

A window cleaning machine includes a base, a walking device, a cleaning device, an air extraction device, a first primary scraper, and a driving module. The walking device propels the window cleaning machine to move on a surface. The cleaning device includes a suction cup, and the suction cup and the surface are configured to form an enclosed space to enable the window cleaning machine to move on the surface without falling due to gravity. The air extraction device is configured to generate negative pressure in the enclosed space. A first primary scraper is located on a first side of the base. The driving module is connected to the first primary scraper to control the first primary scraper to switch between an operating state of contacting the surface and a separated state of being away from the surface to adapt to different operation conditions.

### CROSS-REFERENCE TO RELATED APPLICATIONS

This application claims priority of No. 114100806 filed in Taiwan on 2025/Jan. 8 under 35 USC 119, the entire content of which is hereby incorporated by reference.

### BACKGROUND OF THE INVENTION

### Field of the Invention

The present invention relates to a window cleaning machine, and more particular to a window cleaning machine having scrapers.

### Description of the Prior Art

FIG. 1 shows a perspective diagram of a window cleaning machine 10 of the prior art. FIG. 2 shows a section diagram of the window cleaning machine 10 along the section line A-A in FIG. 1. As shown in FIG. 1, the window cleaning machine 10 is adapted to be attached on a panel 101 and move on the panel 101 to clean dust or stains on a surface of the panel 101. The panel 101 may be a vertical window. The window cleaning machine 10 includes a housing 110, a spray module 114 and a suction cup 116. FIG. 2 shows that the window cleaning disc 10 further includes a walking assembly 111 and a walking assembly 112 to move the window cleaning machine 10. The walking assembly 111 and the walking assembly 112 may be assemblies such as pulleys and rollers able to generate movements, so as to propel the window cleaning machine 101 to move forward, move backward and turn on the surface of the panel 101. In the embodiment shown, the walking component 111 or the walking assembly 112 is a pulley, and includes a crawler and two driving wheels driving the crawler. In one embodiment, the walking assembly 111 and the walking assembly 112 are in contact with the surface of the panel 101 and are coplanar with the suction cup 116.

Referring to FIG. 1, the housing 110 of the window cleaning machine 10 is provided with an accommodation space, and the spray module 114 is embedded in the accommodation space of the housing 110. Moreover, the accommodation space may be located on a side surface of the window cleaning machine 10, such that the spray module 114 is placed on the side surface of the window cleaning machine 10 to better spray a cleaning liquid onto the surface of the panel 101. The spray module 114 is detachable to be more readily removed and cleaned or filled with a cleaning liquid by a user. The cleaning liquid includes clean water or a cleaning agent. As shown in FIG. 1, the spray module 114 is embedded in the accommodation space of the housing 110, and the spray module 114 has a fastener 314 to fasten with the housing 110 so as to be securely held on the window cleaning machine 10. The spray module 114 is not embedded in the window cleaning machine 10, but is sucked or attached on the housing 110 of the window cleaning machine 10.

Referring to FIG. 2, the window cleaning machine 10 has an air extraction module 130 located in the housing 110, the housing 110 and the suction cup 116 have a space in between, and the space is in communication with the air extraction module 130 via an air intake device 119, such that the air intake device 119 and the air extraction module 130 draw away air in the space during operation. The air intake device 119 consists of an impeller. The air extraction module 130 includes a pump. During operation, the window cleaning machine 10 is placed on the panel 101, and the panel 101, the housing 110 and the suction cup 116 at this point jointly define an enclosed space S. By drawing away the air in the enclosed space S by the air extraction module 130, negative pressure is formed in the enclosed space S, thereby sucking the window cleaning machine 10 on a working surface of the panel 101. Moreover, a border of the suction cup 116 defines a first region Aa. A region formed by an abutting portion of the suction cup 116 and the housing 110 is defined as a second region Aw. An area of the first region Aa subtracted by an area of the second region Aw is equal to an area of a remaining region Ac.

Referring to FIG. 2, the suction cup 116 may further include a cleaning cloth 171 attached to a bottom surface of the suction cup 116. The cleaning cloth 171 is elastic, and may be formed of a material such as plant fiber, animal fiber or synthetic fiber. When negative pressure is generated in the enclosed space and a force of action is generated by atmospheric pressure upon the window cleaning machine 10, the window cleaning machine 10 may be pressed in an airtight manner on the panel 101, and the airtightness of the enclosed space S is maintained by the cleaning cloth 171.

### SUMMARY OF THE INVENTION

It is an object of the present invention to provide a window cleaning machine at least provided with a scraper, which accurately switches between a contacting state and a separated state by a controllable driving module so as to adapt to different operation conditions.

A window cleaning machine provided according to an embodiment of the present invention is to move on a surface of a non-horizontal plane, and includes a base, a walking device, a cleaning device, an air extraction device, a first primary scraper, and a driving module. The walking device is coupled to the base to propel the window cleaning machine to move on the surface. The cleaning device includes a suction cup which is coupled on the base. During operation, the base, the suction cup and the surface are configured to form an enclosed space, such that the window cleaning machine moves on the surface without falling due to gravity. The air suction device is coupled to the base and in communication with the enclosed space, and is configured to generate negative pressure in the enclosed space. The first primary scraper is located on a first side of the base. The driving module is connected to the first primary scraper to control the first primary scraper to switch between an operating state of contacting the surface and a separated state of being away from the surface.

In one embodiment, when the window cleaning machine moves in a non-horizontal direction, the driving module lifts the first primary scraper to the separated state of being away from the surface, wherein a vector of the non-horizontal direction includes a direction opposite to that of gravity.

In one embodiment, when the window cleaning machine is in a state of moving in the forward direction, the first primary scraper is located on a front side of the base; when the window cleaning machine moves in the forward direction, the driving module lifts the first primary scraper to the separated state of being away from the surface.

In one embodiment, the window cleaning machine further includes a second primary scraper located on a second side of he base, wherein the second side is opposite to the first side. The driving module is further connected to the second primary scraper to control the second primary scraper to switch between the operating state of contacting the surface and the separated state of being away from the surface.

In one embodiment, when the window cleaning machine moves in a non-horizontal direction, the driving module lifts the first primary scraper and the second primary scraper to the separated state of being away from the surface, wherein a vector of the non-horizontal direction includes a direction opposite to that of gravity.

When the window cleaning machine is in a state of moving in the forward direction, the first primary scraper is located on a front side of the base, and the second primary scraper is located on a rear side of the base. When the window cleaning machine moves in the forward direction, the driving module lifts the first primary scraper to the separated state of being away from the surface. When the window cleaning machine moves in the forward direction, the driving module lowers the second primary scraper to the operating state of contacting the surface. When the window cleaning machine moves in the backward direction, the driving module lifts the second primary scraper to the separated state of being away from the surface, and when the window cleaning machine moves in the backward direction, the driving module lowers the first primary scraper to the operating state of contacting the surface.

In one embodiment, an angle between the non-horizontal direction and an upward direction is less than or equal to 45 degrees, wherein the upward direction is a direction opposite to that of gravity.

In one embodiment, the cleaning device further includes a cleaning material (fabric), which is for contacting the surface during operation and is located at the suction cup.

In one embodiment, the window cleaning machine further includes a clean water tank, which stores a cleaning liquid and provides the cleaning liquid to the cleaning device.

In one embodiment, the window cleaning machine further includes a first surface processing module. The first surface processing module is located on a front side of the base facing the forward direction. The first surface processing module includes the first primary scraper and a first water collection region, wherein the first water collection region is to collect the cleaning liquid scraped off by the first primary scraper.

The window cleaning machine further includes a waste water tank, a first spray pipeline, and a first collection pipeline. The first spray pipeline is connected to the first surface processing module and the clean water tank, to transport the cleaning liquid in the clean water tank to the first surface processing module. The first collection pipeline is connected to the first water collection region and the waste water tank, to transport waste water in the first water collection region to the waste water tank.

The first surface processing module further includes a first secondary scraper. When the window cleaning machine moves in the forward direction, the driving module lifts the first primary scraper to the separated state of being away from the surface, and causes the first secondary scraper to be in the operating state of contacting the surface.

The first surface processing module further includes a first cleaning assembly located between the first primary scraper and the first secondary scraper.

The first water collection region is arranged between the first primary scraper and the first secondary scraper, to collect the cleaning liquid flowing down between the first primary scraper and the first secondary scraper.

The window cleaning machine further includes a second surface processing module. The second surface processing module is located on a rear side of the base having the two sides facing the backward direction, the second surface processing module includes the second primary scraper, a second cleaning assembly, and a second secondary scraper, and the second cleaning assembly is located between the second primary scraper and the second secondary scraper. When the window cleaning machine moves in the forward direction, the driving module lowers the second primary scraper to the operating state of contacting the surface, and lifts the second secondary scraper to the separated state of being away from the surface. When the window cleaning machine moves in the backward direction, the driving module lifts the second primary scraper to the separated state of being away from the surface, and lowers the second secondary scraper to the operating state of contacting the surface. When the window cleaning machine moves in the backward direction, the driving module lifts the first secondary scraper to the separated state of being away from the surface, and lowers the first primary scraper to the operating state of contacting the surface.

In one embodiment, the second surface processing module further includes a second water collection region arranged between the second primary scraper and the second secondary scraper to collect the cleaning liquid flowing down.

In one embodiment, each of the first water collection region and the second water collection region is provided with a water absorbing material.

In one embodiment, the window cleaning machine further includes a second spray pipeline and a second collection pipeline. The second spray pipeline is connected to the clean water tank and the second surface processing module, to transport the cleaning liquid to the second surface processing module. The second collection pipeline is connected to the second water collection region and the waste water tank, to transport waste water in the second water collection region to the waste water tank.

In one embodiment, the cleaning liquid output per unit time by the clean water tank includes a first liquid amount and a second liquid amount. The driving module has a first applied force and a second applied force on the first primary scraper and/or the first secondary scraper. The second liquid amount is greater than the first liquid amount, and the second applied force is greater than the first applied force.

In one embodiment, the window cleaning machine further includes a filter. The filter is in communication between the waste water tank and the clean water tank, and a water pump motor causes waste water in the waste water tank to pass through the filter to become clean water, which then enters the clean water tank.

The clean water tank is provided with a water gauge to measure a water storage capacity of the clean water tank, and the waste water tank is provided with a full water level gauge to detect whether the waste water tank is at a full water level.

The first surface processing module further includes a driving unit. The first cleaning assembly includes a roller brush, and the driving unit is connected to the roller brush and rotates the roller brush to clean the surface.

In conclusion, the window cleaning machine provided by the present invention is at least provided with a scraper accurately switching between the contacting state and the separated state by the controllable driving module so as to adapt to different operation conditions. Preferably, the present invention employs a dual-scraper driving technique to collaboratively operate a primary scraper and a secondary scraper, thereby optimizing cleaning effects and significantly improving cleaning efficiency on a surface. In one embodiment, the window cleaning machine not only effectively solves the problem of residual water stains during a cleaning process, but also achieves optimization in terms of reducing operation complexities and reducing wear of scrapers.

### BRIEF DESCRIPTION OF THE DRAWINGS

The accompanying drawings below are intended to provide illustrative description and explanation for the present invention, and are not to be construed as limitations to the present invention. Wherein,

FIG. 1 is a perspective diagram of a window cleaning machine of the prior art.

FIG. 2 is a section diagram of the window cleaning machine of the prior art in FIG. 1 along a section line A-A.

FIG. 3A is a perspective diagram of a window cleaning machine according to an embodiment of the present invention.

FIG. 3B is a perspective diagram of a window cleaning machine according to another embodiment of the present invention.

FIG. 3C is an exploded diagram of a first surface processing module of a window cleaning machine according to an embodiment of the present invention.

FIG. 4 is a perspective diagram of a window cleaning machine according to another embodiment of the present invention.

FIG. 5 is a bottom view of a window cleaning machine according to an embodiment of the present invention.

FIG. 6 is a schematic diagram of waterways of a window cleaning machine according to an embodiment of the present invention.

FIG. 7 is a perspective diagram from a viewing angle of a second surface processing module of a window cleaning machine according to an embodiment of the present invention.

FIG. 8 is a perspective diagram from another viewing angle of a second surface processing module of a window cleaning machine according to an embodiment of the present invention.

FIG. 9A is a section diagram of a first state of a first surface processing module of a window cleaning machine according to an embodiment of the present invention.

FIG. 9B is a section diagram of a second state of a first surface processing module of a window cleaning machine according to an embodiment of the present invention.

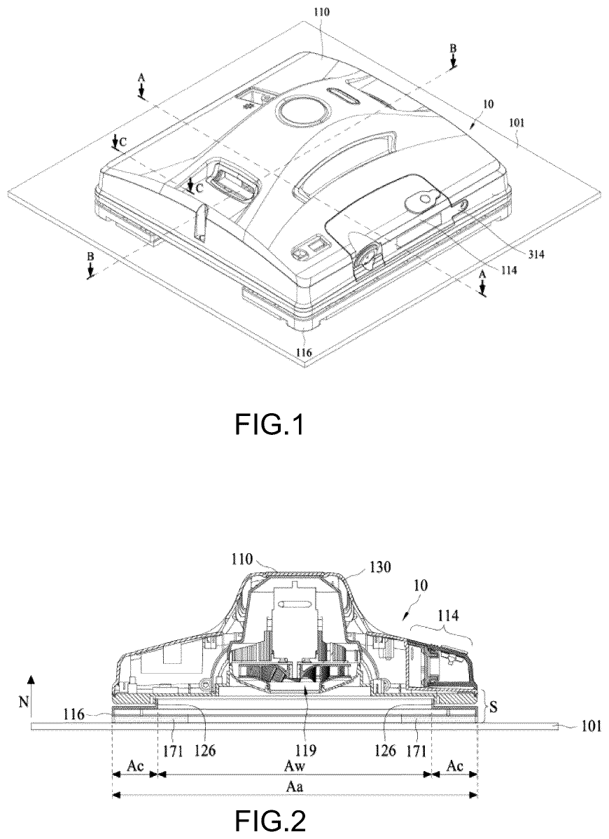

### DETAILED DESCRIPTION OF THE EMBODIMENTS

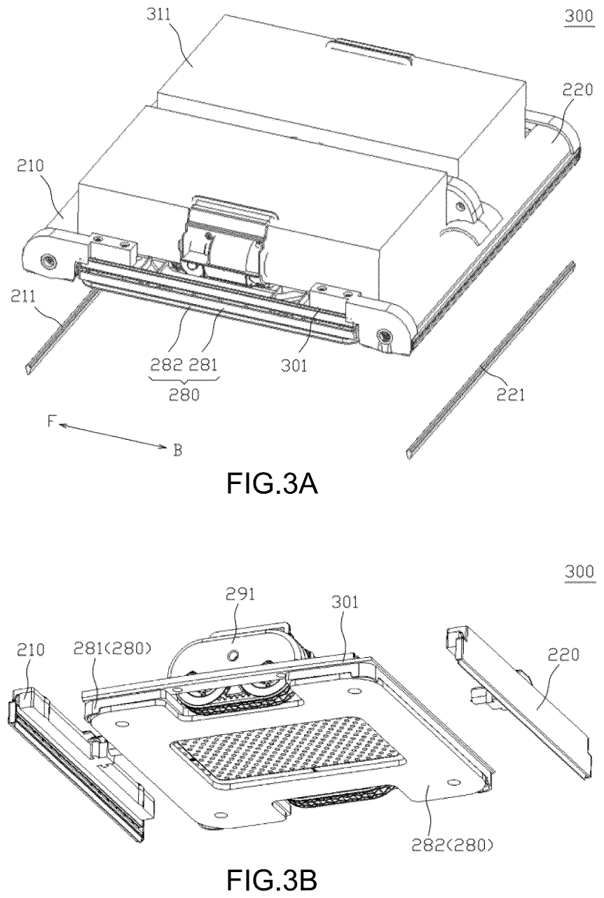

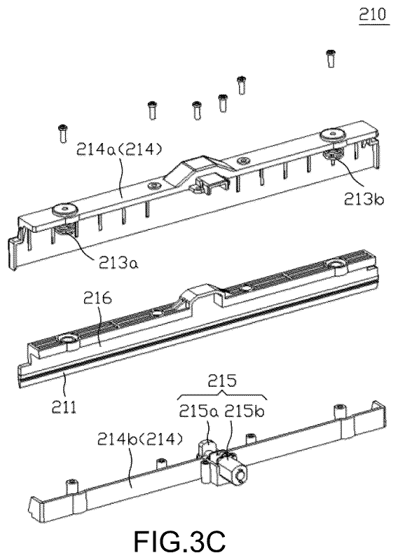

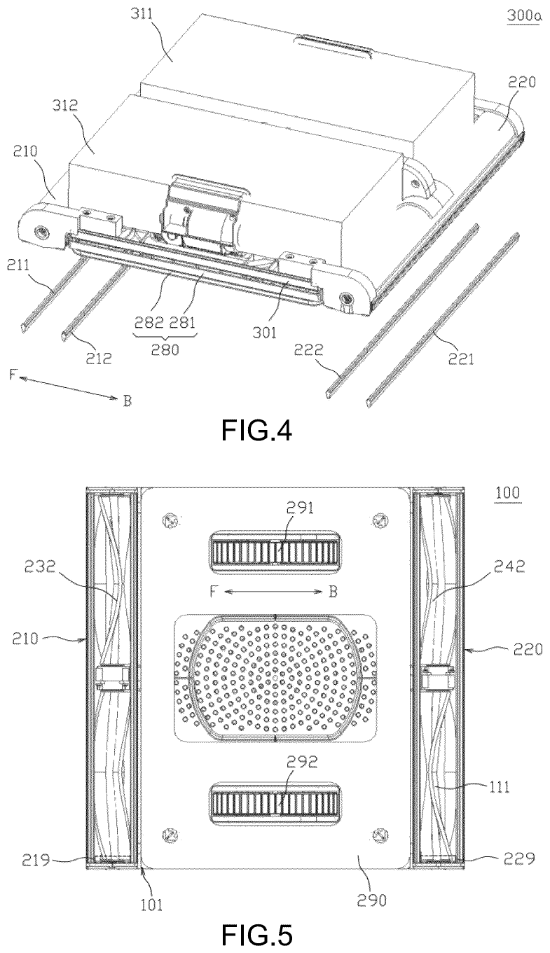

FIG. 3A shows a perspective diagram of a window cleaning machine according to an embodiment of the present invention. FIG. 4 shows a perspective diagram of a window cleaning machine according to another embodiment of the present invention. FIG. 5 shows a bottom view of a window cleaning machine according to an embodiment of the present invention. As shown in FIG. 3A, FIG. 4 and FIG. 5, a window cleaning machine 300 may include a housing, a spray module, and cleaning device 280 including a suction cup. The window cleaning machine 300 may further include a walking assembly 291 and a walking assembly 292 to move the window cleaning machine 300. The housing, the spray module, and the suction cup may be implemented by current components described in the background of the invention or techniques developed in the future. The walking assembly 291 and the walking assembly 292 may be assemblies such as crawler wheels or rollers able to generate movements to propel the window cleaning machine 300 to move forward, move backward and turn on a surface of a panel.

As shown in FIG. 3A, the window cleaning machine 300 further includes a base 301, a first surface processing module 210, and a second surface processing module 220. The first surface processing module 210 and the second surface processing module 220 are located on two sides of the base 301, respectively. In a preferable situation, the first surface processing module 210 is located on a front side of the base 301 facing a forward direction F, and the second surface processing module 220 is located on a rear side of the base 301 facing a backward direction B. The first surface processing module 210 includes a first primary scraper 211, and the second surface processing module 220 includes a second primary scraper 221. When the window cleaning machine 300 is in a state of moving in a forward direction, the first primary scraper 211 is located on a front side of the base 301, and the second primary scraper 221 is located on a rear side of the base 301. The window cleaning machine 300 further includes a scraper driving module connected to the first primary scraper 211 and the second primary scraper 221 to cause the first primary scraper 211 and the second primary scraper 221 to be in an operating state of contacting a surface or a separated state of being away from the surface. The window cleaning machine 300 further includes a clean water tank 311 and a cleaning device 280. The cleaning water tank 311 is for storing a cleaning liquid, and sprays the cleaning liquid to the cleaning device 280. The cleaning device 280 is located on a bottom surface of the base 301 to contact and clean the panel. The cleaning device 280 includes a suction cup 281 which is coupled on the base 301. During operation, the base 301, the suction cup 281, and the surface are configured to form an enclosed space, such that the window cleaning machine moves on the surface without falling due to gravity. The cleaning device 280 further includes a cleaning material 282 located below the suction cup 281 to contact the surface during operation, wherein the cleaning material 282 may be a material such as fabric or sponge.

FIG. 3B shows a perspective diagram of a window cleaning machine according to another embodiment of the present invention. FIG. 3C shows an exploded diagram of a first surface processing module of a window cleaning machine according to an embodiment of the present invention. As shown in FIG. 3B and FIG. 3C, the first surface processing module 210 includes a housing 214. The housing 214 includes a first shell 214a and a second shell 214b, which jointly surround and protect internal components. The first surface processing module 210 further includes a driving module 215, the first primary scraper 211, and a scraper support 216. The scraper support 216 is locate between the first shell 214a and the second shell 214b to connect and support the first primary scraper 211. The first shell 214a and the second shell 214b accommodate the scraper support 216 to ensure a secure configuration thereof. The first primary scraper 211 is installed below the scraper support 216, and is pushed downward by pressure generated by a spring 213a and a spring 213b to ensure tight matching with a target surface. To achieve state conversion of the first primary scraper 211, the driving module 215 is arranged at the housing 214 (or the second shell 214b), preferably arranged at a position between the springs 213a and 213b, and more preferably arranged at a center position of the housing 214. The driving module 215 is able to lift or lower the first primary scraper 211 levelly or horizontally when arranged at a position between the spring 213a and the spring 213b. The driving module 215 includes a motor 215b and a cam 215a connected thereto. The driving module 215 controls, by rotating of the a cam 215a, the first primary scraper 211 to switch between the operating state of contacting the surface of the panel 101 and the separated state of being away from the surface of the panel 101, hence increasing flexibility and adaptivity of the module in different application scenarios. This design effectively enhances the operation efficiency and reliability of state conversion of the first primary scraper 211.

When the window cleaning machine 300 moves in the forward direction F, the scraper driving module lifts the first primary scraper 211 of the first surface processing module 210 located on the front side to the separated state of being away from the surface, and lowers the second primary scraper 221 of the second surface processing module 220 located on the rear side to the operating state of contacting the surface. The cleaning device 280, which is wet, leaves water drops on the panel after wiping the panel, and the second primary scraper 221 located behind the cleaning device 280 along the forward direction F scrapes off the water drops on the cleaned part of the panel, and causes the gathered water to flow downward along the second primary scraper 221. When the window cleaning machine 300 moves in the backward direction B, the scraper driving module lifts the second primary scraper 221 of the second surface processing module 220 located on the rear side to the separated state of being away from the surface, and lowers the first primary scraper 211 of the first surface processing module 210 located on the front side to the operating state of contacting the surface. The cleaning device 280, which is wet, leaves water drops on the panel after wiping the panel, and the first primary scraper 211 located behind the cleaning device 280 along the backward direction B scrapes off the water drops on the cleaned part of the panel, and causes the gathered water to flow downward along the first primary scraper 211.

As shown in FIG. 4 and FIG. 5, the first surface processing module 210 includes the first primary scraper 211 and the first secondary scraper 212, and the second surface processing module 220 includes the second primary scraper 221 and the second secondary scraper 222. While performing a cleaning operation, the window cleaning machine 300 sprays water toward a space between the first primary scraper 211 and the first secondary scraper 212, and sprays water toward a space between the second primary scraper 221 and the second secondary scraper 222. Compared to the first secondary scraper 212, the first primary scraper 211 is located on an outer side or a front side of the window cleaning machine 300. Compared to the second secondary scraper 222, the second primary scraper 221 is located on an outer side or a rear side of the window cleaning machine 300. In other words, each of the first secondary scraper 212 and the second secondary scraper 222 is located between the first primary scraper 211 and the second primary scraper 221.

When the window cleaning machine 300 moves in the forward direction F, the scraper driving module lifts the first primary scraper 211 of the first surface processing module 210 located on the front side to the separated state of being away from the surface, and lowers the first secondary scraper 212 to the operating state of contacting the surface. The first secondary scraper 212 scrapes off the water drops between the first primary scraper 211 and the first secondary scraper 212, and causes the gathered water to flow downward along the first secondary scraper 212. Moreover, the second primary scraper 221 of the second surface processing module 220 located on the rear side is lowered to the operating state of contacting the surface, and the second secondary scraper 222 is lifted to the separated state of being away from the surface. The second primary scraper 221 scrapes off the water drops between the second primary scraper 221 and the second secondary scraper 222, and causes the gathered water to flow downward along the second primary scraper 221.

As shown in FIG. 5, the first surface processing module 210 may further include a first water collection region 219. When the window cleaning machine 300 is in a state of performing a cleaning operation, the first water collection region 219 is located at a bottom portion of the first surface processing module 210, and is located between the first primary scraper 211 and the first secondary scraper 212 to collect the water scraped off by the first primary scraper 211 and the first secondary scraper 212.

When the window cleaning machine 300 moves in the backward direction B, the scraper driving module lifts the second primary scraper 221 of the second surface processing module 220 located on the rear side to the separated state of being away from the surface, and lowers the second secondary scraper 222 to the operating state of contacting the surface. The second secondary scraper 222 scrapes off the water drops between the second primary scraper 221 and the second secondary scraper 222 from the panel, and causes the gathered water to flow downward along the second secondary scraper 222. Moreover, the first secondary scraper 212 of the first surface processing module 210 is lifted to the separated state of being away from the surface, and the first primary scraper 211 is lowered to the operating state of contacting the surface. The first primary scraper 211 scrapes off the water drops between the first primary scraper 211 and the first secondary scraper 212 from the panel, and causes the gathered water to flow downward along the first primary scraper 211.

As shown in FIG. 5, the second surface processing module 220 may further include a second water collection region 229. When the window cleaning machine 300 is in a state of performing a cleaning operation, the second water collection region 229 is located at a bottom portion of the second surface processing module 220, and is located between the second primary scraper 221 and the second secondary scraper 222 to collect the water scraped off by the second primary scraper 221 and the second secondary scraper 222.

In one embodiment, a water absorbing material, for example, sponge, may be arranged in the first water collection region 219 and the second water collection region 229.

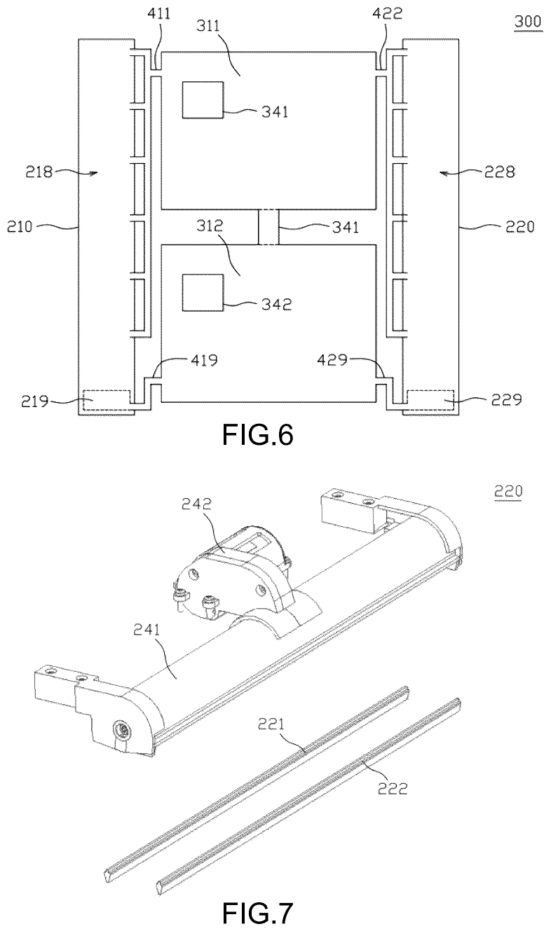

In one embodiment, the window cleaning machine 300 further includes a waste water tank 312 to collect waste water from the first water collection region 219 and the second water collection region 229. FIG. 6 shows a schematic diagram of waterways of a window cleaning machine according to an embodiment of the present invention. In one embodiment, as shown in FIG. 6, the window cleaning machine 300 further includes a first motor 341, a second motor 324, a first spray pipeline 411, a first collection pipeline 419 and the waste water tank 312. The first spray pipeline 411 is in communication between the clean water tank 311 and a first accommodation space 218 defined by the first surface processing module 210, draws the cleaning liquid from the clean water tank 311 by the first motor 341 of the driving module, and sprays the clean water into the first accommodation space 218 through the first spray pipeline 411. The first collection pipeline 419 is in communication between the waste water tank 312 and the first accommodation space 218, draws a waste liquid collected in the first water collection region 219 from the first water collection region 219 by the second motor 342 of the driving module, and transports the waste liquid into the waste water tank 312.

In one embodiment, as shown in FIG. 6, the window cleaning machine 300 further includes a second spray pipeline 422, a second collection pipeline 429 and the waste water tank 312. The second spray pipeline 422 is in communication between the waste water tank 312 and a second accommodation space 228 defined by the second surface processing module 220, draws the cleaning liquid from the clean water tank 311 by the first motor 341 of the driving module, and sprays the clean water into the second accommodation space 228 through the second spray pipeline 422. The second collection pipeline 429 is in communication between the waste water tank 312 and the second accommodation space 228, draws the waste liquid collected in the second water collection region 229 from the second water collection region 229 by the second motor 342 of the driving module, and transports the waste liquid into the waste water tank 312.

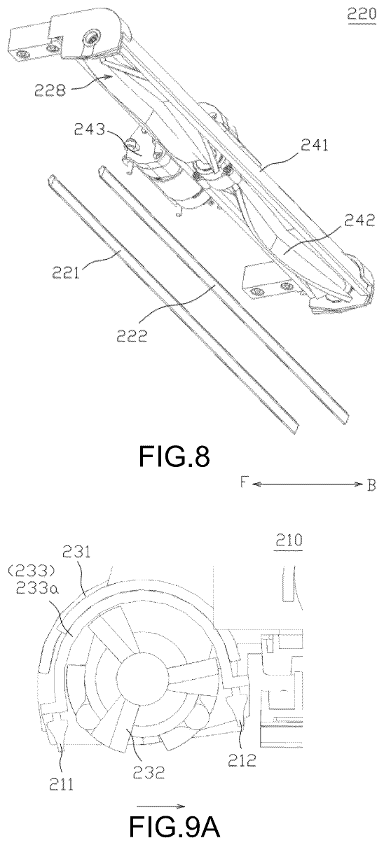

The first surface processing module 210 may be implemented by the same structure as the second surface processing module 220, and the difference between the two merely lies in symmetrical structures. Thus, in the description below, related details on the first surface processing module 210 are omitted when the second surface processing module 220 is described, and related details of the second surface processing module 220 are omitted when the first surface processing module 210 is described. In one embodiment, the second surface processing module 210 further includes a first cleaning assembly. The second surface processing module 220 further includes a second cleaning assembly. Each of the first cleaning assembly and the second cleaning assembly may be a flat panel or a roller brush. In one embodiment, the first cleaning assembly may be a first roller brush 232. The second cleaning assembly may be a second roller brush 242. FIG. 7 shows a perspective diagram from a viewing angle of a second surface processing module of a window cleaning machine according to an embodiment of the present invention. FIG. 8 shows a perspective diagram from another viewing angle of a second surface processing module of a window cleaning machine according to an embodiment of the present invention. As shown in FIG. 7 and FIG. 8, the second surface processing module 220 further includes a second roller brush casing 241, a second roller brush 242, and a second driving module 243. The second roller brush casing 241 defines the second accommodation space 228, and the second roller brush 242 is arranged in the second accommodation space 228. The second driving module 243 is connected to the second roller brush 242 and rotates the second roller brush 242 to clean the panel. More specifically, the second driving module 243 includes a roller brush motor, which is connected to the second roller brush 242 to drive the second roller brush 242 to rotate.

In this embodiment, the window cleaning machine 300 adopts dual-driving modules in combination with roller brush and scraper techniques to adapt to different cleaning requirements. More specifically, with accurate driving control, the roller brushes and the scrapers are ensured to operate in a most suitable state, and an automatic adjustment function provides flexible and highly efficient cleaning operations. The design concept of the present invention not only enhances cleaning efficiency, but at the same time also reduces operation complexities and improves overall stability of the machine.

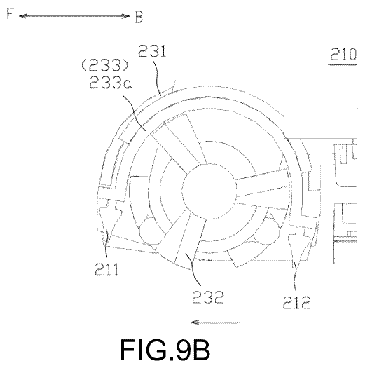

FIG. 9A and FIG. 9B show section diagrams of two states of a first surface processing module of a window cleaning machine according to an embodiment of the present invention, wherein FIG. 9A shows a first state and FIG. 9B shows a second state. The first surface processing module 210 includes a scraper driving module 233. The scraper driving module 233 includes a scraper support 233a and a scraper motor (not shown). Two ends of the scraper support 233a are provided with the first primary scraper 211 and the first secondary scraper 212, respectively, and the scraper motor is connected to the scraper support 233a and selectively inclines or rotates the scraper support 233 toward a direction.

As shown in FIG. 9A, in the first state where the window cleaning machine 300 moves in the backward direction B, the scraper support 233a of the scraper driving module 233 inclines toward the left or rotates in a counterclockwise direction, such that the first secondary scraper 212 of the first surface processing module 210 located on the front side is lifted to the separated state of being away from the surface, and the first primary scraper 211 is lowered to the operating state of contacting the surface. The first primary scraper 211 scrapes off the water drops between the first primary scraper 211 and the first secondary scraper 212 from the panel.

As shown in FIG. 9B, in the second state where the window cleaning machine 300 moves in the forward direction F, the scraper support 233a of the scraper driving module 233 inclines toward the right or rotates in a clockwise direction, such that the first primary scraper 211 of the first surface processing module 210 located on the front side is lifted to the separated state of being away from the surface, and the first secondary scraper 212 is lowered to the operating state of contacting the surface. The first secondary scraper 212 scrapes off the water drops between the first primary scraper 211 and the first secondary scraper 212 from the panel.

According to an embodiment of the present invention, in contribution to the first surface processing module 210 and the second surface processing module 220 able to operate separately in the window cleaning machine 300, as well as the design of the scraper driving module 233 and the multiple scrapers provided, contact states of the multiple scrapers can be flexibly controlled during movements of the window cleaning machine 300 to achieve effective cleaning of a panel. During movements in the forward direction F or the backward direction B, the multiple primary scrapers and secondary scrapers are able to automatically adjust positions thereof according to requirements, so as to ensure that water drops are thoroughly scraped off to enhance cleaning effects.

In one embodiment, forces applied by the scraper driving module 233 on the first primary scraper 211 and the first secondary scraper 212 may be coordinated with a liquid outlet amount of the clean water tank 311. As the liquid outlet amount of the clean water tank 311 increases, the forces applied by the scraper driving module 233 on the first primary scraper 211 and the first secondary scraper 212 also increase, so that biases of the first primary scraper 211 and the first secondary scraper 212 on the panel also increase. More specifically, the cleaning liquid output per unit time by the clean water tank 311 includes a first liquid amount and a second liquid amount, and the scraper driving module 233 includes a first applied force and a second applied force on the first primary scraper 211 and the first secondary scraper 212, wherein the second liquid amount is greater than the first liquid amount and the second applied force is greater than the first applied force. The applied force may be a force of reaction or a torque.

In the embodiment in FIG. 3A, when the window cleaning machine 300 moves in a direction of a non-horizontal plane, the driving modules of the first surface processing module 210 and the second surface processing module 220 respectively lift the first primary scraper 211 and the second primary scraper 221 to the separated state of being away from the surface, wherein a vector of the non-horizontal direction includes a direction opposite to that of gravity. Preferably, the direction of a non-horizontal plane refers to an upward direction. That is, when the window cleaning machine 300 moves upward, the first primary scraper 211 and the second primary scraper 221 are respectively lifted to the separated state of being away from the surface. Since the first primary scraper 211 and the second primary scraper 221 are respectively lifted to the separated state of being away from the surface when the window cleaning machine 300 moves upward, frictional and resistive forces can be effectively decreased to reduce power consumption, and burdens on driving components of the window cleaning machine are also alleviated. Meanwhile, such design is also able to prevent wear of scrapers caused by reverse friction to prolong durability of the scrapers. Moreover, such configuration provides the window cleaning machine with higher flexibility for non-horizontal movements, allowing the window cleaning machine to move more smoothly on a window surface to thereby improve the overall cleaning efficiency. Once the window cleaning machine 300 reaches a target position, the driving modules again lower the first primary scraper 211 and the second primary scraper 221 to restore them to a state of closely attaching to the window surface to perform a cleaning function and ensure that cleaning effects are unaffected. Such design not only enhances the adaptivity of the window cleaning machine on window surfaces of various angles, but also at the same time significantly improves security to prevent risks of loss of control potentially caused by unexpected operations and overloading. As the reasons given above, in the embodiment in FIG. 4, the driving modules of the first surface processing module 210 and the second surface processing module 220 respectively lift the first primary scraper 211, the first secondary scraper 212, the second primary scraper 221, and the second secondary scraper 222 to the separated state of being away from the surface.

Moreover, in this embodiment, the first water collection region 219 and the second water collection region 229 are connected to the waste water tank 312, so as to effectively manage waste water produced during the cleaning process. This prevents the waste water from remaining on the surface of the panel to upkeep consistency of cleaning effects, and at the same time improves efficiency of cleaning tasks. In one embodiment, since a circulation system design may be further provided between the clean water tank 311 and the waste water tank 312, the use of the cleaning liquid can become even more efficient. For example, in one embodiment, a filter 431 is provided between the clean water tank 311 and the waste water tank 312, and a first motor 341 causes the waste water in the waste water tank 312 to pass through the filter 431 to become clean water, which then enters the clean water tank 311, hence refilling water into the clean water tank 311.

In conclusion, the window cleaning machine 300 of the present invention is at least provided with a scraper accurately switching between the contacting state and the separated state by the controllable driving module so as to adapt to different operation conditions. Preferably, the present invention employs a dual-scraper driving technique to collaboratively operate a primary scraper and a secondary scraper, thereby optimizing cleaning effects and significantly improving cleaning efficiency on a surface. In one embodiment, the window cleaning machine not only effectively solves the problem of residual water stains during a cleaning process, but also achieves optimization in terms of reducing operation complexities and reducing wear of scrapers. Moreover, the automatic adjustment function further ensures flexibility of the machine to enable the machine to adapt to different environments and cleaning requirements.

What is claimed is:

1. A window cleaning machine to move on a surface of a non-horizontal plane, the window cleaning machine comprising:
a base;
a walking device, coupled to the base to propel the window cleaning machine to move on the surface;
a cleaning device, coupled to the base, the base, the cleaning device and the surface configured to form an enclosed space during operation, to enable the window cleaning machine to move on the surface without falling due to gravity;
an air extraction device, coupled to the base and in communication with the enclosed space, configured to generate negative pressure in the enclosed space;
a first primary scraper, located on a first side of the base; and
a driving module, connected to the first primary scraper to control the first primary scraper to switch between an operating state of contacting the surface and a separated state of being away from the surface.

2. The window cleaning machine of claim 1, wherein when the window cleaning machine moves in a non-horizontal direction on the surface, the driving module lifts the first primary scraper to the separated state of being away from the surface, wherein a vector of the non-horizontal direction includes a direction opposite to that of gravity.

3. The window cleaning machine of claim 1, wherein when the window cleaning machine is in a state of moving in a forward direction, the first primary scraper is located on a front side of the base, and when the window cleaning machine moves in the forward direction, the driving module lifts the first primary scraper to the separated state of being away from the surface.

4. The window cleaning machine of claim 3, further comprising:
a second primary scraper, located on a second side of the base, the second side being opposite to the first side, wherein
the driving module is further connected to the second primary scraper to control the second primary scraper to switch between the operating state of contacting the surface and the separated state of being away from the surface.

5. The window cleaning machine of claim 4, wherein when the window cleaning machine moves in a non-horizontal direction, the driving module lifts the first primary scraper and the second primary scraper to the separated state of being away from the surface, wherein a vector of the non-horizontal direction includes a direction opposite to that of gravity.

6. The window cleaning machine of claim 4, wherein
when the window cleaning machine is in a state of moving in a forward direction, the first primary scraper is located on a front side of the base, and the second primary scraper is located on a rear side of the base;
when the window cleaning machine moves in the forward direction, the driving module lifts the first primary scraper to the separated state of being away from the surface;
when the window cleaning machine moves in the forward direction, the driving module lowers the second primary scraper to the operating state of contacting the surface;
when the window cleaning machine moves in a backward direction, the driving module lifts the second primary scraper to the separated state of being away from the surface; and
when the window cleaning machine moves in the backward direction, the driving module lowers the first primary scraper to the operating state of contacting the surface.

7. The window cleaning machine of claim 5, wherein an angle between the non-horizontal direction and an upward direction is less than or equal to 45 degrees, wherein the upward direction is a direction opposite to that of gravity.

8. The window cleaning machine of claim 4, wherein the cleaning device comprises a suction cup and a cleaning material, and the cleaning material is provided at the suction cup and is for contacting the surface during operation.

9. The window cleaning machine of claim 4, further comprising:
a clean water tank, storing a cleaning liquid, and providing the cleaning liquid to the cleaning device.

10. The window cleaning machine of claim 9, further comprising:
a first surface processing module, located on a front side of the base facing the forward direction, the first surface processing module comprising the first primary scraper and a first water collection region, wherein the first water collection region is configured to collect the cleaning liquid scraped off by the first primary scraper.

11. The window cleaning machine of claim 10, further comprising a waste water tank, a first spray pipeline, and a first collection pipeline, wherein
the first spray pipeline is connected to the first surface processing module and the clean water tank, to transport the cleaning liquid in the clean water tank to the first surface processing module, and
the first collection pipeline is connected to the first water collection region and the waste water tank, to transport waste water in the first water collection region to the waste water tank.

12. The window cleaning machine of claim 11, wherein the first surface processing module further comprises a first secondary scraper, and when the window cleaning machine moves in the forward direction, the driving module lifts the first primary scraper to the separated state of being away from the surface, and causes the first secondary scraper to be in the operating state of contacting the surface.

13. The window cleaning machine of claim 12, wherein the first surface processing module further comprises a first cleaning assembly located between the first primary scraper and the first secondary scraper.

14. The window cleaning machine of claim 13, wherein the first water collection region is arranged between the first primary scraper and the first secondary scraper, to collect the cleaning liquid flowing down between the first primary scraper and the first secondary scraper.

15. The window cleaning machine of claim 14, further comprising:
a second surface processing module, located on a rear side of the base facing the backward direction, the second surface processing module comprising the second primary scraper, a second cleaning assembly, and a second secondary scraper, and the second cleaning assembly located between the second primary scraper and the second secondary scraper; wherein
when the window cleaning machine moves in the forward direction, the driving module lowers the second primary scraper to the operating state of contacting the surface, and lifts the second secondary scraper to the separated state of being away from the surface;
when the window cleaning machine moves in the backward direction, the driving module lifts the second primary scraper to the separated state of being away from the surface, and lowers the second secondary scraper to the operating state of contacting the surface; and
when the window cleaning machine moves in the backward direction, the driving module lifts the first secondary scraper to the separated state of being away from the surface, and lowers the first primary scraper to the operating state of contacting the surface.

16. The window cleaning machine of claim 15, wherein the second surface processing module further comprises a second water collection region arranged between the second primary scraper and the second secondary scraper to collect the cleaning liquid flowing down.

17. The window cleaning machine of claim 16, wherein each of the first water collection region and the second water collection region is provided with a water absorbing material.

18. The window cleaning machine of claim 17, further comprising a second spray pipeline and a second collection pipeline, wherein
the second spray pipeline is connected to the clean water tank and the second surface processing module, to transport the cleaning liquid to the second surface processing module, and
the second collection pipeline is connected to the second water collection region and the waste water tank, to transport waste water in the second water collection region to the waste water tank.

19. The window cleaning machine of claim 18, wherein a liquid amount of the cleaning liquid output per unit time by the clean water tank comprises a first liquid amount in a first period and a second liquid amount in second period; a force applied on the first primary scraper and/or the first secondary scraper by the driving module comprises a first applied force in the first period and a second applied force in the second period; the second liquid amount is greater than the first liquid amount, and the second applied force is greater than the first applied force.

20. The window cleaning machine of claim 18, further comprising:
a filter, in communication between the waste water tank and the clean water tank, wherein a water pump motor causes waste water in the waste water tank to pass through the filter to become clean water, which then enters the clean water tank,
wherein the clean water tank is provided with a water gauge to detect a water storage capacity of the clean water tank, and the waste water tank is provided with a full water level gauge to detect whether the waste water tank is at a full water level,
wherein the first surface processing module further comprises a driving unit; the first cleaning assembly comprises a roller brush, and the driving unit is connected to the roller brush and rotates the roller brush to clean the surface.
